(19) United States
(12) Patent Application Publication
(10) Pub. No.: US 2010/0115164 A1
(43) Pub. Date: May 6, 2010

(54) Mobile Device Combining Business Card with Chip

(76) Inventors: Yen-Hui Huang, Dajia Town (TW); Po-Jen Lai, Dajia Town (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/262,224

(22) Filed: Oct. 31, 2008

(51) Int. Cl. G06F 13/00

(52) U.S. Cl. 710/100

(57) ABSTRACT

A mobile device combining a business card with at least one chip comprises: a chip sensing device; a data transforming device connected to the chip sensing device; a microprocessor connected to the data transforming device; a display interface connected to the microprocessor for showing the data of the chip; an operation interface able to change the property of the data of the chip and connected to the microprocessor; a memory for the microprocessor storing the data of the chip; and a power supply system for the mobile device; wherein the chip sensing device is disposed in the mobile device and has two modes for receiving data, to keep a certain distance between the business card with the chip and the mobile device is to let the mobile device sense the data of the chip of the business card through the chip sensing device.

### BACKGROUND OF THE INVENTION

1. Field of the Invention

The present invention generally relates to a mobile device combining a business card with a chip, more particularly to a mobile device with a chip sensing device, so that the data of the chip of the business card of another mobile device are transmitted to the mobile device through a wireless transmission in order to let a user watch and compile.

2. Description of the Prior Art

Regular paper business cards are used to exchange the information, such as company name, name, title, e-mail address, company address, etc., of business persons for the first meeting. Although the technology is going further, many products replace the paper business card. One of the products is as a reader for a diskette 40. The reader can be disposed on the shell of a mobile phone 30, as shown in FIG. 4, or externally connected to the mobile phone 30. Through the way of inserting the diskette 40 into a reading slot 33 of the mobile phone 30 is to capture the data of the diskette 40, so that the captured data can be digitalized and stored in the mobile phone 30, then shown on an LCD 32. Such data are compiled by a key 31, and it seems that the consumption of prior paper business card is reduced indeed.

The prior art as aforesaid does have the following disadvantages:
1. The prior diskette reader spends longer time to read and grab information, in other words, it is not effective.
2. The prior diskette reader is disposed on the shell of the mobile phone or externally connected to the mobile phone, so that an appearance is not good from the point of view, and it is not convenient as well.

Therefore, how to figure out the disadvantages of the prior arts is an important issue to the skilled people in the related field.

### SUMMARY OF THE INVENTION

The disadvantages of prior arts to be solved are listed below:
1. Paper business cards are the way of people normally exchanging their information, or a mobile phone with a diskette reader transforms the information into digital data. But aforesaid may be inconvenient to be sorted or take longer time to read.
2. Another way is to use a mobile phone with a camera to take the picture of a business card in order to store the digital data of the picture. But the process of capturing the data takes longer time as well, and the resolution of the picture is not good enough.

The present invention provides a mobile device combining a business card with a chip can solve above disadvantages. The mobile device has the function of wireless sensing and reading a chip. Each user only hold the mobile device combining the business card with the chip to close to another user with the same type of mobile device, then the data in each chip can be rapidly exchanged by a wireless transmission within a certain distance. Such exchanged data can then be compiled and stored.

With comparison to prior arts, the present invention has the advantages as follows:
1. The present invention provides the mobile device combining the business card with the chip so as to sense and read the business information of the business card through a wireless transmission to the mobile device for compiling and storing.
2. The present invention is capable of rapidly capturing the business information in the chip in order to avoid the conditions of spending time to insert card for reading, and the captured data are integrated with the problem of low resolution.
3. The present invention digitalizes the information on the normal business card, and then displays the digitalized data on a screen with different modes of presentation.

Other and further features, advantages, and benefits of the invention will become apparent in the following description taken in conjunction with the following drawings. It is to be understood that the foregoing general description and following detailed description are exemplary and explanatory but are not to be restrictive of the invention. The accompanying drawings are incorporated in and constitute a part of this application and, together with the description, serve to explain the principles of the invention in general terms. Like numerals refer to like parts throughout the disclosure.

### BRIEF DESCRIPTION OF THE DRAWINGS

The objects, spirits, and advantages of the preferred embodiments of the present invention will be readily understood by the accompanying drawings and detailed descriptions, wherein:

FIG. 1 illustrates a schematic 3-D view of using the presentation;

FIG. 2 illustrates a block diagram of a preferred embodiment of the present invention;

FIG. 3 illustrates a flow chart of the preferred embodiment of the present invention; and

FIG. 4 illustrates a schematic 3-D view of a prior art.

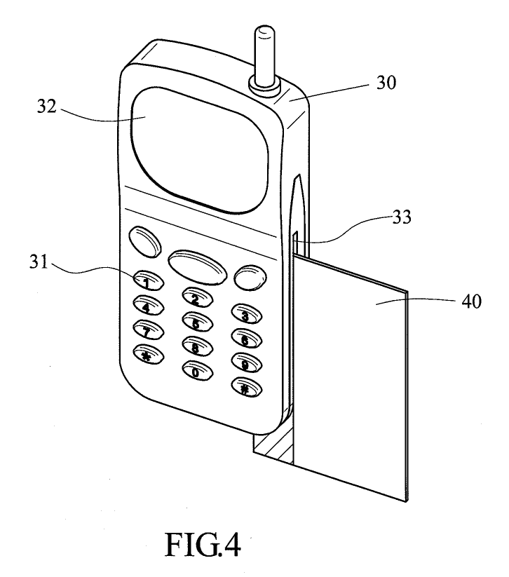

### DETAILED DESCRIPTION OF THE INVENTION

Following preferred embodiments and figures will be described in detail so as to approach aforesaid object.

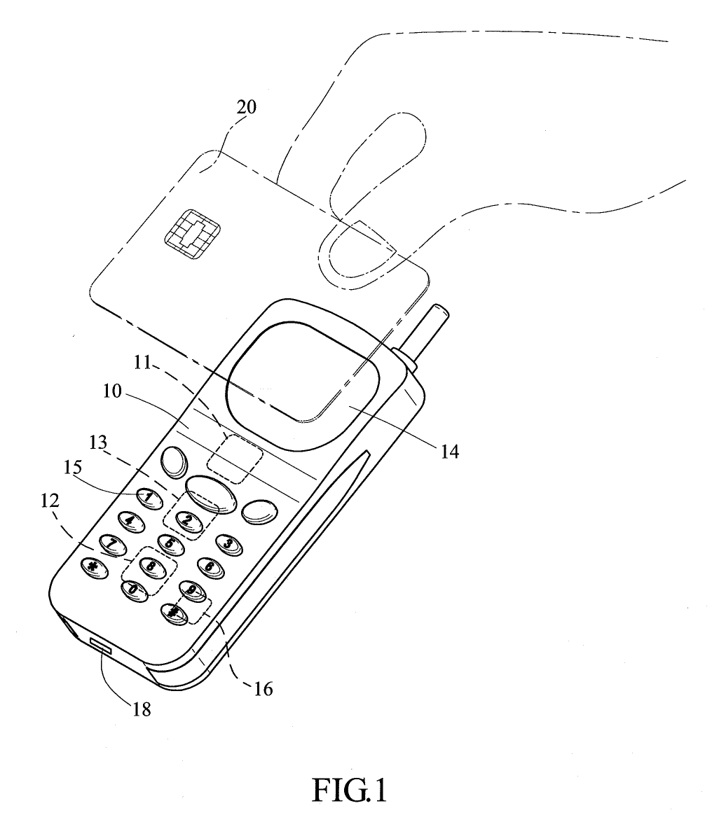

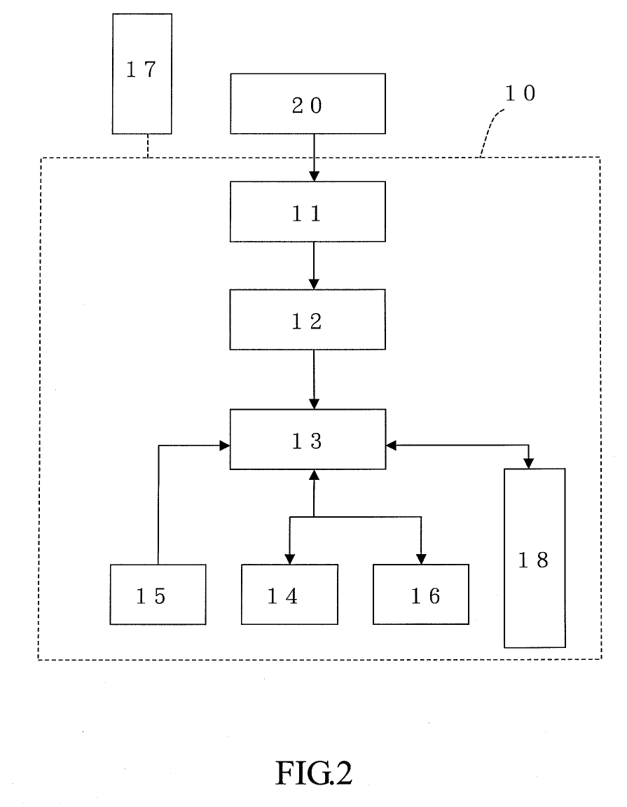

With references to FIG. 1 to FIG. 3, the present invention discloses a mobile device combining a business card with at least one chip. The mobile device 10 basically has the functions of a regular mobile phone and further includes a chip sensing device 11, a data transforming device 12 connected to the chip sensing device 11, a microprocessor 13 connected to the data transforming device 12, a display interface 14 connected to the microprocessor 13 for showing the data of the chip, an operation interface 15 able to change the property of the data of the chip and connected to the microprocessor 13, a memory 16 for the microprocessor 13 storing the data of the chip, and a power supply system 17 for the mobile device 10; wherein the chip sensing device 11 is disposed in the mobile device 10, to keep a certain distance between the business card 20 with the chip and the mobile device 10 may let the mobile device 10 sense the data of the chip of the business card 20 through the chip sensing device 11, the data are then transformed by the data transforming device 12 and readable to the microprocessor 13, the transformations include decoding, digital-analog conversion and analog-digital conversion, the transferred data are transmitted to the display interface 14 for references of a user, who can compile the transferred data through the operation interface 15.

The chip sensing device 11 is an RFID transmission module.

The mobile device 10 further has an output interface 18 in order to output data to other electronic devices.

The output interface 18 is a USB interface.

The chip sensing device 11 has two modes for receiving data, one is an allowing data receiving mode and another is a refusing data receiving mode.

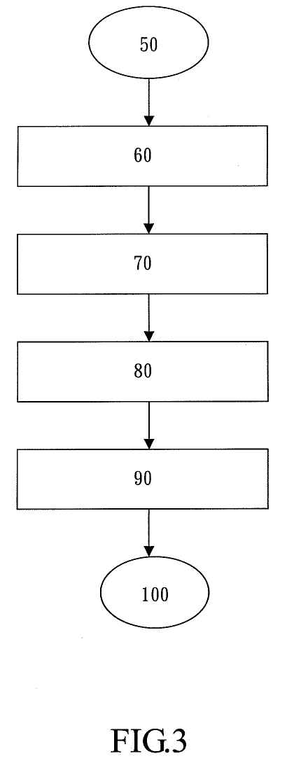

Again, with reference to FIG. 3, the present invention is able to exchange the data. The method for exchanging the data includes the steps of: (50) receiving the data; (60) setting the chip sensing device into an activation mode; (70) taking the business card with the chip close to the mobile device; (80) the display interface showing the data of the chip; (90) identifying a plurality of data which are not compiled as the function of not answered calls of a regular mobile phone, and the user determining whether the plurality of data are compiled or stored so as to exchange the data; and (100) end. Thus, the present invention has the convenience in order to replace the usages of prior paper business cards and chip readers; instead, the memory is used to store a large number of data of business cards in order to avoid the condition of holding not sorted and miscellaneous business cards; further, digital displaying may represent the data with plenty types.

The mobile device combining the business card with the chip has an in-time updating system, which transmits the data of the chip of the business card in the mobile device to the data base of the computer host of a company. The company may have a plurality of sales persons, who bring the mobile device to go outside for collecting the data of new customers, hence the data of new customers are then transmitted to the data base of the company for immediately updating and sorting so as to effectively integrate the whole data.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A mobile device combining a business card with at least one chip comprising:
a chip sensing device;
a data transforming device connected to the chip sensing device;
a microprocessor connected to the data transforming device;
a display interface connected to the microprocessor for showing the data of the chip;
an operation interface able to change the property of the data of the chip and connected to the microprocessor;
a memory for the microprocessor storing the data of the chip; and
a power supply system for the mobile device;
wherein the chip sensing device is disposed in the mobile device, the chip sensing device being an RFID transmission module and having two modes for receiving data, one being an allowing data receiving mode and another being a refusing data receiving mode, to keep a certain distance between the business card with the chip and the mobile device in order to let the mobile device sense the data of the chip of the business card through the chip sensing device, the data being then transformed by the data transforming device and readable to the microprocessor, the transferred data being transmitted to the display interface for references of a user, who can compile the transferred data through the operation interface, wherein the mobile device has an in-time updating system, which transmits the data of the chip of the business card in the mobile device to a data base of a computer host of a company, the computer proceeding the actions of in-time updating, sorting and compiling.

2. The mobile device combining the business card with the chip according to claim 1, wherein the mobile device further has an output interface in order to output data to other electronic devices.

3. The mobile device combining the business card with the chip according to claim 2, wherein the output interface is a USB interface.
